(19) United States
(12) Patent Application Publication
(10) Pub. No.: US 2026/0022984 A1
(43) Pub. Date: Jan. 22, 2026

(54) PRESSURE SENSOR AND DETECTION DEVICE

(71) Applicants: BEIJING BOE OPTOELECTRONICS TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Qiuxu Wei, Beijing (CN); Yue Li, Beijing (CN); Lihui Wang, Beijing (CN); Weilong Guo, Beijing (CN); Wenbo Chang, Beijing (CN); Taonan Zhang, Beijing (CN); Jie Sun, Beijing (CN); Nana He, Beijing (CN); Feng Qu, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(21) Appl. No.: 18/995,690

(22) PCT Filed: Apr. 18, 2024
(86) PCT No.: PCT/CN2024/088673

§ 371 Date: Jan. 16, 2025

(30) Foreign Application Priority Data
May 31, 2023 (CN) 202310640404.6

(51) Int. Cl. G01L 9/00; G01L 17/00

(52) U.S. Cl. CPC G01L 9/0042; G01L 9/007; G01L 9/0073; G01L 17/00

(57) ABSTRACT

Provided is a pressure sensor, including: a first substrate; a second substrate having a pressure-sensitive membrane, a pressure reference cavity is provided between the pressure-sensitive membrane and the first substrate, the pressure-sensitive membrane is configured to deform; a capacitor having a first/second electrode plate, the first electrode plate being disposed on the first substrate, the second electrode plate being disposed on the pressure-sensitive membrane; a detection inductor having coil structures, each coil structure includes a first trace, a second trace and a conductive post; the first trace is disposed on a side of the first substrate, the second trace is disposed on the other side of the first substrate, orthographic projections of the first trace and the second trace on the first substrate intersect, the first trace is connected to the second trace at an intersection position; the detection inductor and the capacitor form a resonant circuit.

### CROSS-REFERENCE TO RELATED APPLICATIONS

This application claims priority to Chinese patent application No. 202310640404.6, titled “PRESSURE SENSOR AND DETECTION DEVICE”, submitted to the China National Intellectual Property Administration on May 31, 2023, the entire contents of which are incorporated herein by reference.

### TECHNICAL FIELD

This application relates to the technical field of pressure sensors, in particular to a pressure sensor and a detection device.

### BACKGROUND

For pressure detection in closed environments such as pressure detection in medical implantation or tire pressure detection in automobiles, pressure sensors based on inductance-capacitance resonant circuits are usually adopted. Such pressure sensors in the related art are either relatively large in dimensions or poor in accuracy.

### SUMMARY

Embodiments of this application provide a pressure sensor and a detection device with a small size and high accuracy.

To achieve the above objectives, the embodiments of this application adopt the following technical solutions.

On aspect provides a pressure sensor, including:
a first substrate;
a second substrate, the second substrate includes a pressure-sensitive membrane that is opposite to and spaced apart from the first substrate, a sealed pressure reference cavity is provided between the pressure-sensitive membrane and the first substrate, and the pressure-sensitive membrane is configured to deform towards or away from the first substrate;
a capacitor, including a first electrode plate and a second electrode plate arranged opposite to each other, the first electrode plate being disposed on the first substrate, and the second electrode plate being disposed on the pressure-sensitive membrane;
a detection inductor, including a plurality of coil structures connected in sequence, each of the coil structures includes a first trace, a second trace and a conductive post; the first trace is disposed on a side of the first substrate facing the second substrate, the second trace is disposed on a side of the first substrate away from the second substrate, an orthographic projection of the first trace on the first substrate and an orthographic projection of the second trace on the first substrate intersect with each other, and the first trace is electrically connected to the second trace at an intersection position through the conductive post;
the detection inductor and the capacitor are connected in series to form an inductance-capacitance resonant circuit.

In some embodiments, the capacitor includes a first capacitor and a second capacitor, the first electrode plate includes a first sub-electrode plate and a second sub-electrode plate that are arranged separately, the first sub-electrode plate and the second electrode plate form the first capacitor, and the second sub-electrode plate and the second electrode plate form the second capacitor; a first end of the detection inductor is electrically connected to the first sub-electrode plate, and a second end of the detection inductor is electrically connected to the second sub-electrode plate.

In some embodiments, the pressure sensor further includes a first conductive layer located on a side of the first trace away from the first substrate, wherein the first sub-electrode plate and the second sub-electrode plate are located in the first conductive layer.

In some embodiments, an orthogonal projection area of the first sub-electrode plate with respect to the second electrode plate is a first area, an orthogonal projection area of the second sub-electrode plate with respect to the second electrode plate is a second area, and the first area is equal to the second area.

In some embodiments, the pressure sensor further includes a second conductive layer and a first insulation layer, the first trace is located in the second conductive layer, and the first insulation layer is arranged between the first conductive layer and the second conductive layer.

In some embodiments, the first end of the detection inductor is the first trace, and the first trace is electrically connected to the first sub-electrode plate through a via hole.

In some embodiments, the second end of the detection inductor is the conductive post, and the conductive post is electrically connected to the first sub-electrode plate through a via hole.

In some embodiments, the second electrode plate includes a third sub-electrode plate and a fourth sub-electrode plate that are arranged separately, the third sub-electrode plate and the first electrode plate form the first capacitor, and the fourth sub-electrode plate and the first electrode plate form the second capacitor; a first end of the detection inductor is electrically connected to the third sub-electrode plate, and a second end of the detection inductor is electrically connected to the fourth sub-electrode plate.

In some embodiments, the second substrate is a silicon substrate, and partial region of the second substrate is doped and forms the second electrode plate.

In some embodiments, the pressure-sensitive membrane includes a first region and a second region surrounding the first region, an edge of the second region away from the first region is fixed, and a thickness of the first region is greater than that of the second region.

In some embodiments, the second substrate is provided with a groove, and the groove is located in the second region.

In some embodiments, the groove is located on a side of the second substrate away from the first substrate.

In some embodiments, the conductive posts are arranged in an array to form a first conductive post column, a second conductive post column and a plurality of conductive post rows, the first conductive post column includes a plurality of first conductive posts arranged at intervals in a first direction, the second conductive post column comprises a plurality of second conductive posts arranged at intervals in the first direction, and each of the conductive post rows comprises one of the first conductive posts and one of the second conductive posts arranged at intervals in a second direction, the first direction and the second direction intersect with each other; one end of the first trace is electrically connected to one of the first conductive posts located in one of the conductive post rows, and the other end of the first trace is electrically connected to one of the second conductive posts located in another adjacent one of the conductive post rows; one end of the second trace is electrically connected to one of the first conductive posts located in one of the conductive post rows, and the other end of the second trace is electrically connected to one of the second conductive posts located in the same one of the conductive post rows.

In some embodiments, a second insulation layer is provided on a side of the second trace away from the first substrate.

Another aspect provides a preparation method for a pressure sensor, including:
forming a first electrode plate and a detection inductor on a first substrate, the detection inductor includes a plurality of coil structures connected in sequence, each of the coil structures includes a first trace, a second trace and a conductive post, the first trace is disposed on a side of the first substrate facing the second substrate, the second trace is disposed on a side of the first substrate away from the second substrate, an orthographic projection of the first trace on the first substrate and an orthographic projection of the second trace on the first substrate intersect with each other, and the first trace is electrically connected to the second trace at an intersection position through the conductive post;
forming a second electrode plate on a second substrate, the second substrate includes a pressure-sensitive membrane, and the second electrode plate is arranged on the pressure-sensitive membrane;
connecting the first substrate to the second substrate; after the first substrate is connected to the second substrate, a sealed pressure reference cavity is formed between the pressure-sensitive membrane and the first substrate, the pressure-sensitive membrane is allowed to deform towards or away from the first substrate, the first electrode plate and the second electrode plate form a capacitor, and the detection inductor and the capacitor are connected in series to form an inductance-capacitance resonant circuit.

Another aspect provides a detection device, including:
the pressure sensor described above; and
a detection circuit including a read inductor, the read inductor is configured to be coupled with the detection inductor in the pressure sensor to read a resonant frequency of the pressure sensor.

### BRIEF DESCRIPTION OF THE DRAWINGS

In order to describe technical solutions of the embodiments of the present disclosure or the related art more clearly, the accompanying drawings used in the illustration of the embodiments or the related art will be briefly introduced. Apparently, the accompanying drawings in the following explanation illustrate merely some embodiments of the present disclosure, and those skilled in the art may obtain other accompanying drawings based on these accompanying drawings without paying any creative effort.

FIG. 1 is a schematic structural block diagram of a detection device;

FIG. 2 is a schematic circuit schematic diagram of a detection device;

FIG. 3 schematically shows a read inductor;

FIG. 4 schematically shows a top view of a pressure sensor;

FIG. 5 is a cross-sectional view along A-A in FIG. 4;

FIG. 6 schematically shows a top view of partial structures of a pressure sensor;

FIG. 7 schematically shows a bottom view of partial structures of a pressure sensor;

FIG. 8 schematically shows a top view of partial structures of a pressure sensor;

FIG. 9 is a partial cross-sectional view along B-B in FIG. 8;

FIG. 10 schematically shows a circuit schematic diagram of another pressure sensor;

FIG. 11 is a cross-sectional view along C-C in FIG. 8;

FIG. 12 schematically shows a top view of the pressure sensor with the second substrate removed;

FIG. 13 schematically shows a cross-sectional view of another pressure sensor;

FIG. 14 is a schematic flowchart of a preparation method for a pressure sensor;

FIG. 15 is a flowchart of sub-steps included in step $100;

FIG. 16 to FIG. 21 are partial process flowcharts in the preparation method for the pressure sensor;

FIG. 22 is a flowchart of sub-steps included in step S200;

FIG. 23 and FIG. 24 are partial process flowcharts in the preparation method for the pressure sensor.

### DETAILED DESCRIPTION

A clear and thorough description for solutions in the embodiments of the present disclosure will be given below in conjunction with the accompanying drawings in the embodiments of the present disclosure. Apparently, the described embodiments are a part of embodiments of the present disclosure, not all the embodiments. All other embodiments obtained, based on the embodiments in the present disclosure, by those skilled in the art without paying creative effort fall within the protection scope of the present disclosure.

In the embodiments of this application, terms such as “first”, “second”, “third”, and “fourth” are used to distinguish the same or similar items with basically the same functions and effects. These terms are only for clearly describing the technical solutions of the embodiments of this application and should not be understood as indicating or implying relative importance or implicitly indicating the number of the indicated technical features.

In the embodiments of this application, “multiple/a plurality of” means two or more, and “at least one” means one or more, unless otherwise clearly and specifically defined.

In the embodiments of this application, the orientation or positional relationship indicated by terms such as “upper” and “lower” is based on the orientation or positional relationship shown in the accompanying drawings, which is only for the convenience of describing this application and simplifying the description, and does not indicate or imply that the device or element referred to must have a specific orientation, be constructed and operated in a specific orientation. Therefore, it should not be understood as a limitation on this application.

The embodiments of this application provide a detection device for detecting the pressure of, for example, gas or liquid. Exemplarily, the detection device can be used in pressure detection scenarios in closed environments such as pressure detection in medical implantations and tire pressure detection in automobiles.

FIG. 1 schematically shows a structural block diagram of a detection device. As shown in FIG. 1, the detection device 1000 includes a pressure sensor 100 and a detection circuit 200. The pressure sensor 100 is placed in an environment to be detected, and is configured to convert a pressure received into an electrical signal. The detection circuit 200 is configured to read the electrical signal from the pressure sensor 100, and calculate the pressure value received by the pressure sensor 100.

Since the detection device 1000 can be used to detect the pressure in a closed environment, the pressure sensor 100 may adopt a wireless passive pressure sensor based on an inductance-capacitance resonant circuit (LC resonant circuit), and the detection circuit 200 has no direct physical connection with the pressure sensor 100.

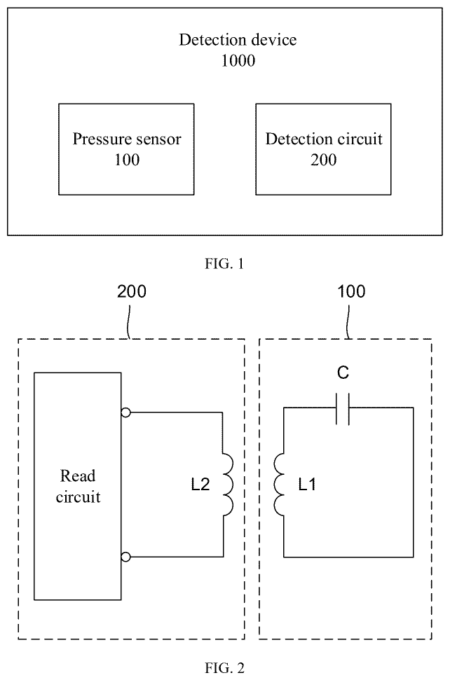

FIG. 2 schematically shows a circuit schematic diagram of a detection device. As shown in FIG. 2, the pressure sensor 100 includes a detection inductor L1 and a capacitor C. The detection inductor L1 and the capacitor C are connected in series to form an LC resonant circuit. When the pressure received by the pressure sensor 100 changes, the capacitance value of the capacitor C changes. Moreover, since the resonant frequency of the LC resonant circuit is related to the capacitance of the capacitor C, when the capacitance value of the capacitor C changes, the resonant frequency of the LC resonant circuit also changes. Therefore, the capacitance value of the capacitor C can be calculated by obtaining the resonant frequency of the pressure sensor 100, and then the pressure received by the pressure sensor 100 can be calculated.

The detection circuit 200 includes a read inductor L2 and a read circuit electrically connected to the read inductor L2. The read inductor L2 may be coupled with the detection inductor L1.

Exemplarily, when the detection device 1000 is in operation, the read circuit sends an excitation signal to the detection inductor L1 through the read inductor L2, so as to excite the LC resonant circuit of the pressure sensor 100 to resonate. Moreover, the read inductor L2 reads the resonant frequency of the LC resonant circuit through the detection inductor L1, then the capacitance value of the capacitor C is calculated according to the resonant frequency, and the pressure received by the pressure sensor 100 is calculated according to the capacitance value of the capacitor C.

In order to improve the coupling effect between the read inductor L2 and the detection inductor L1, an angle between the axis of the read inductor L2 and the axis of the detection inductor L1 can be less than or equal to 45°.

Exemplarily, the axes of the read inductor L2 and the detection inductor L1 are collinear.

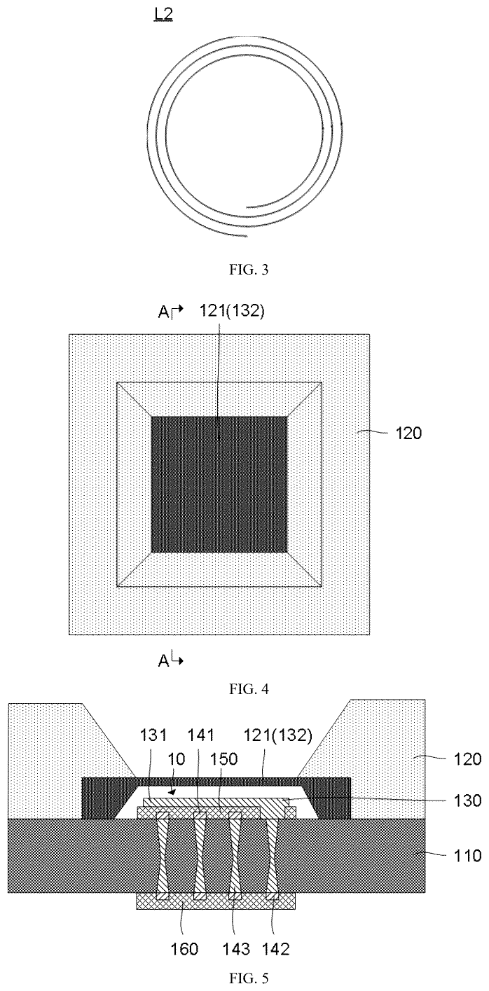

The read inductor L2 may have various structures. FIG. 3 schematically shows a read inductor. Exemplarily, as shown in FIG. 3, the read inductor L2 is a planar inductor. That is, the read inductor L2 is a multi-turn spiral line formed on a plane.

Exemplarily, the number of spiral turns of the read inductor L2 is 2 to 20 turns, and the outermost diameter of the read inductor L2 ranges from 10 to 100 mm.

When the read inductor L2 is a planar inductor, in order to improve the coupling effect between the read inductor L2 and the detection inductor L1, an orthographic projection of the detection inductor L1 on a plane where the read inductor L2 is located is within the range of the outermost spiral line of the read inductor L2.

Of course, the read inductor L2 may also be an inductor with a three-dimensional structure. The embodiments of this application do not limit the structural form of the read inductor L2, as long as it can be coupled with the detection inductor L1 to read the resonant frequency of the pressure sensor 100 through the detection inductor L1.

FIG. 4 schematically shows a top view of a pressure sensor, and FIG. 5 is a cross-sectional view along A-A in FIG. 4. As shown in FIG. 4 and FIG. 5, the pressure sensor 100 includes a first substrate 110, a second substrate 120, a capacitor, and an inductor.

The second substrate 120 includes a pressure-sensitive membrane 121. The pressure-sensitive membrane 121 is opposite to and spaced apart from the first substrate 110, and a sealed pressure reference cavity 10 is provided between the pressure-sensitive membrane 121 and the first substrate 110. The pressure-sensitive membrane 121 can deform when subjected to pressure. The pressure reference cavity 10 separates the pressure-sensitive membrane 121 from the first substrate 110, and forms a space for the deformation of the pressure-sensitive membrane 121. For example, when the pressure-sensitive membrane 121 is subjected to pressure directed towards the first substrate 110, the pressure-sensitive membrane 121 can deform in a direction towards the first substrate 110. When the pressure-sensitive membrane 121 is subjected to pressure directed away from the first substrate 110, the pressure-sensitive membrane 121 can deform in a direction away from the first substrate 110.

Exemplarily, the thickness of the pressure-sensitive membrane 121 is 5 to 50 μm.

Exemplarily, when the pressure-sensitive membrane 121 is quadrilateral, the side length of the pressure-sensitive membrane 121 may be 0.5 to 5 mm.

Among them, the pressure reference cavity 10 may be filled with air or can be a vacuum cavity. If the pressure reference cavity 10 is filled with air, when the pressure inside the pressure reference cavity 10 is greater than the pressure outside the pressure reference cavity 10, the pressure-sensitive membrane 121 can deform in the direction away from the first substrate 110; when the pressure inside the pressure reference cavity 10 is less than the pressure outside the pressure reference cavity 10, the pressure-sensitive membrane 121 can deform in the direction towards the first substrate 110. If the pressure reference cavity 10 is a vacuum cavity, the pressure inside the pressure reference cavity 10 is always zero, which can prevent the environmental temperature from affecting the pressure inside the pressure reference cavity 10 and make the pressure sensor 100 more accurate.

Exemplarily, the second substrate 120 and the first substrate 110 are arranged opposite to each other. The second substrate 120 includes a central region at the center and an edge region surrounding the central region. The edge region of the second substrate 120 is hermetically connected to the first substrate 110, so that the central region of the second substrate 120 and the first substrate 110 enclose a sealed pressure reference cavity 10, and the pressure-sensitive membrane 121 is located in the central region of the second substrate 120.

The pressure reference cavity 10 can be formed in various ways. For example, grooves can be opened on the first substrate 110 and/or the second substrate 120, and the pressure reference cavity 10 can be enclosed at the grooves.

Exemplarily, continuing to refer to FIG. 5, a groove is provided on the side of the central region of the second substrate 120 facing the first substrate 110, and the groove and the first substrate 110 enclose the pressure reference cavity 10. The thickness of the central region becomes thinner due to the groove provided in the central region of the second substrate 120, so that the pressure-sensitive membrane 121 located in the central region is more likely to deform, and the pressure sensor 100 is more sensitive.

Exemplarily, a groove is provided in a region of the first substrate 110 opposite to the central region, and the groove and the second substrate 120 enclose the pressure reference cavity 10. In the actual application process, the thickness of the first substrate 110 is usually greater than that of the second substrate 120. By opening a groove on the first substrate 110, damage caused by the reduction in strength because of opening a groove on the second substrate 120 can be prevented.

Exemplarily, a first groove is provided in the region of the first substrate 110 opposite to the central region, and a second groove is provided on the side of the central region of the second substrate 120 facing the first substrate 110. The first groove and the second groove engage to form the pressure reference cavity 10. When the dimension of the pressure reference cavity 10 is fixed in the direction perpendicular to the first substrate 110, by opening both the first groove and the second groove, the groove depths of the first groove and the second groove can be reduced, thereby preventing the first substrate 110 and the second substrate 120 from having too low strength due to the grooves.

The first substrate 110 and the second substrate 120 may be glass substrates, or silicon substrates. Alternatively, one of them may be a glass substrate and the other is a silicon substrate. The embodiments of this application do not limit the materials of the first substrate 110 and the second substrate 120.

Exemplarily, the first substrate 110 is a glass substrate, and the second substrate 120 is a silicon substrate.

Exemplarily, when the first substrate 110 is a glass substrate, the thickness of the first substrate 110 is 50 to 700 μm.

Exemplarily, when the second substrate 120 is a silicon substrate, the thickness of the second substrate 120 is 50 to 700 μm, and the resistivity is greater than or equal to 1 Ω·cm.

Continuing to refer to FIG. 5, the capacitor includes a first electrode plate 131 and a second electrode plate 132. The first electrode plate 131 and the second electrode plate 132 are made of conductive materials, and at least part of the first electrode plate 131 and the second electrode plate 132 are directly opposite to each other. The first electrode plate 131 is disposed on the first substrate 110, and the second electrode plate 132 is disposed on the pressure-sensitive membrane 121.

Here, the second electrode plate 132 being disposed on the pressure-sensitive membrane 121 means that part or all of the second electrode plate 132 is disposed on the pressure-sensitive membrane 121. When the pressure-sensitive membrane 121 deforms, the pressure-sensitive membrane 121 drives the second electrode plate 132 to move, changing the gap between the first electrode plate 131 and the second electrode plate 132, and thus changing the capacitance value of the capacitor. For example, when the pressure-sensitive membrane 121 deforms in the direction towards the first substrate 110, the gap between the first electrode plate 131 and the second electrode plate 132 becomes smaller. When the pressure-sensitive membrane 121 deforms in the direction away from the first substrate 110, the gap between the first electrode plate 131 and the second electrode plate 132 becomes larger.

The second electrode plate 132 may be arranged on either the side of the pressure-sensitive membrane 121 facing the first substrate 110, or the side of the pressure-sensitive membrane 121 away from the first substrate 110. When the second electrode plate 132 is arranged on the side of the pressure-sensitive membrane 121 facing the first substrate 110, the second electrode plate 132 is located inside the sealed pressure reference cavity 10, so that the second electrode plate 132 is isolated from external particles such as water and oxygen, which can prevent the second electrode plate 132 from being corroded, and can protect the second electrode plate 132 from mechanical damage such as scratches. When the second electrode plate 132 is arranged on the side of the pressure-sensitive membrane 121 away from the first substrate 110, the pressure-sensitive membrane 121 is located between the first electrode plate 131 and the second electrode plate 132, which can prevent short-circuiting between the first electrode plate 131 and the second electrode plate 132.

The first electrode plate 131 may be arranged on the side of the first substrate 110 facing the second substrate 120, that is, the first electrode plate 131 is located inside the sealed pressure reference cavity 10, so that the first electrode plate 131 is isolated from external particles such as water and oxygen, which can prevent the first electrode plate 131 from being corroded, and can protect the first electrode plate 131 from mechanical damage such as scratches. Exemplarily, the thickness of the first electrode plate 131 is 10 to 1000 nm.

Exemplarily, when the first electrode plate 131 is rectangular, the long side edge of the first electrode plate 131 is 0.5 to 5 mm, and the short side edge of the first electrode plate 131 is 0.25 to 2.5 mm.

Exemplarily, the material of the first electrode plate 131 may be one or more of Ti, Cr, and Au.

The detection inductor in the related art mainly has two structures. One structure is the ferrite core inductor. The inductor with such structure is relatively large in volume and cannot be prepared by Micro-Electro-Mechanical (MEMS) technology. Therefore, its integration with the above-mentioned first substrate, second substrate and capacitor is poor. The other structure is the planar wound inductor. Although the planar wound inductor can be prepared by MEMS technology and improves the integration with the first substrate, second substrate and capacitor, the inductance of the planar wound inductor is relatively small, resulting in a poor coupling effect between the detection inductor and the read inductor.

In view of the above, in the pressure sensor provided in the embodiments of this application, the detection inductor is an inductor with a three-dimensional structure formed on the first substrate 110, and the detection inductor includes a plurality of coil structures connected in sequence.

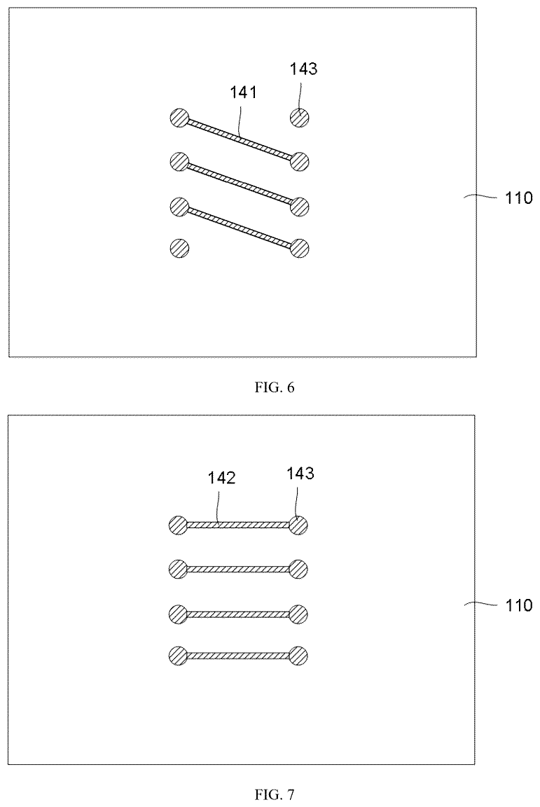

FIG. 6 schematically shows a top view of partial structures of the pressure sensor. As shown in FIG. 6, the coil structure includes first traces 141 arranged on the side of the first substrate 110 facing the second substrate 120. FIG. 7 schematically shows a bottom view of partial structures of the pressure sensor. As shown in FIG. 7, the coil structure also includes second traces 142 arranged on the side of the first substrate 110 away from the second substrate 120. FIG. 8 schematically shows a top view of partial structures of the pressure sensor, where the dotted lines in FIG. 8 indicate orthographic projections of the second traces 142 on the first substrate 110. As shown in FIG. 8, the orthographic projection of the first trace 141 on the first substrate 110 intersects with the orthographic projection of the second trace 142 on the first substrate 110, and the first traces 141 and the second traces 142 are electrically connected at intersection positions through conductive posts 143.

The first substrate 110 may be provided with through holes penetrating through the first substrate 110 in the thickness direction. The conductive posts 143 are arranged in the through holes. For each of the conductive posts, one end of the conductive post 143 is electrically connected to the first trace 141, and the other end of the conductive post 143 is electrically connected to the second trace 142.

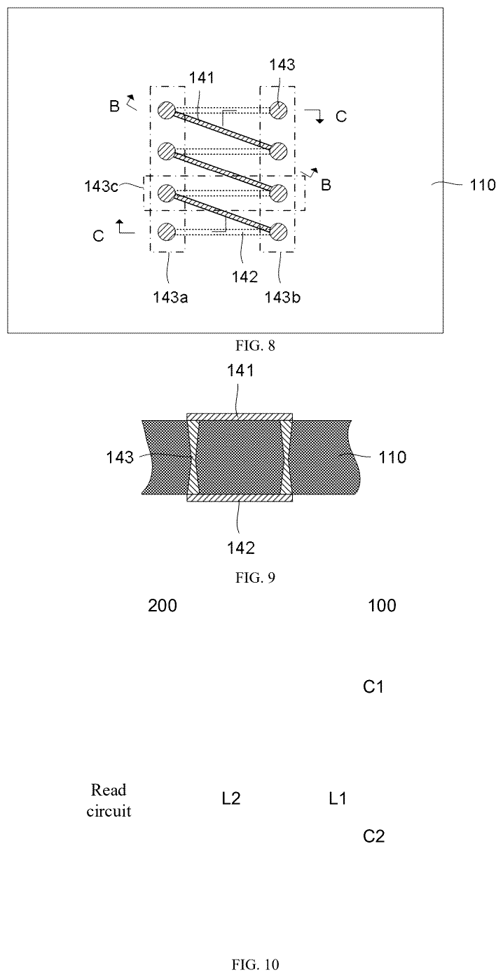

FIG. 9 is a partial sectional view along B-B in FIG. 8. Exemplarily, as shown in FIG. 9, one coil structure includes one piece of first trace 141, one piece of second trace 142 and two conductive posts 143. In one coil structure, the orthographic projection of the first end of the first trace 141 on the first substrate 110 at least partially overlaps with the orthographic projection of the first end of the second trace 142 on the first substrate 110. The first end of the first trace 141 and the first end of the second trace 142 are electrically connected through one conductive post 143, and the second end of the first trace 141/the second trace 142 in this coil structure is electrically connected to another conductive post 143.

Exemplarily, the thickness of the first trace 141 and the second trace 142 is 10 to 1000 nm, and the line width is 3 to 50 μm.

A second insulation layer 160 may be provided on the side of the second trace 142 away from the first substrate 110. The second insulation layer 160 can protect the second trace 142 from being corroded by particles such as water and oxygen, and can prevent the second trace 142 from being damaged by mechanical impacts such as collisions and scratches.

Exemplarily, the material of the second insulation layer 160 may be one or more of PI, SiO, and SiN.

Exemplarily, the thickness of the second insulation layer 160 is 0.1 to 10 μm.

The detection inductor may include a plurality of coil structures that are arranged in a direction parallel to the first substrate 110 and connected in sequence. Exemplarily, the detection inductor includes more than two coil structures.

Exemplarily, continuing to refer to FIG. 8, the conductive posts 143 are arranged in an array to form a first conductive post column 143a, a second conductive post column 143b and a plurality of conductive post rows 143c. The first conductive post column 143a includes a plurality of first conductive posts 143 arranged at intervals in the first direction, the second conductive post column 143b includes a plurality of second conductive posts 143 arranged at intervals in the first direction, and the conductive post row 143c includes one first conductive post 143 and one second conductive post 143 arranged at intervals in the second direction. The first direction intersects with the second direction. One end of the first trace 141 is electrically connected to one first conductive post 143 located in one conductive post row 143c, and the other end of the first trace 141 is electrically connected to one second conductive post 143 located in another adjacent conductive post row 143c. One end of the second trace 142 is electrically connected to one first conductive post 143 located in one conductive post row 143c, and the other end of the second trace 142 is electrically connected to one second conductive post 143 located in the same conductive post row 143c.

In the examples shown in FIG. 6 to FIG. 9, the line widths of the first trace 141 and the second trace 142 are smaller than the diameter of the orthographic projection of the conductive post 143 on the first substrate 110. In the actual application process, the line widths of the first trace 141 and the second trace 142 may also be equal to or larger than the diameter of the orthographic projection of the conductive post 143 on the first substrate 110, so as to reduce the resistances of the first trace 141 and the second trace 142, thereby improving the quality factor of the detection inductor and enhancing the signal transmission quality between the read inductor L2 and the detection inductor L1.

The detection inductor L1 and the capacitor are connected in series to form an inductance-capacitance resonant circuit. One end of the detection inductor L1 may be electrically connected to the first electrode plate 131, and the other end of the detection inductor L1 is electrically connected to the second electrode plate 132.

In the pressure sensor 100 provided in the embodiments of this application, the detection inductor is an inductor with a three-dimensional structure formed on the first substrate 110. Compared with the ferrite core inductor in the related art, the detection inductor in the embodiments of this application can be formed on the first substrate 110 by using MEMS technology, which improves the integration degree of the pressure sensor 100 and reduces the volume of the pressure sensor 100. Compared with the planar inductor in the related art, the detection inductor in the embodiments of this application is an inductor with a three-dimensional structure, including multi-turn coil structures, which increases the inductance and thus improves the signal transmission quality between the read inductor L2 and the detection inductor L1. This allows the pressure sensor 100 to reduce its volume on the premise of maintaining a relatively high signal transmission quality.

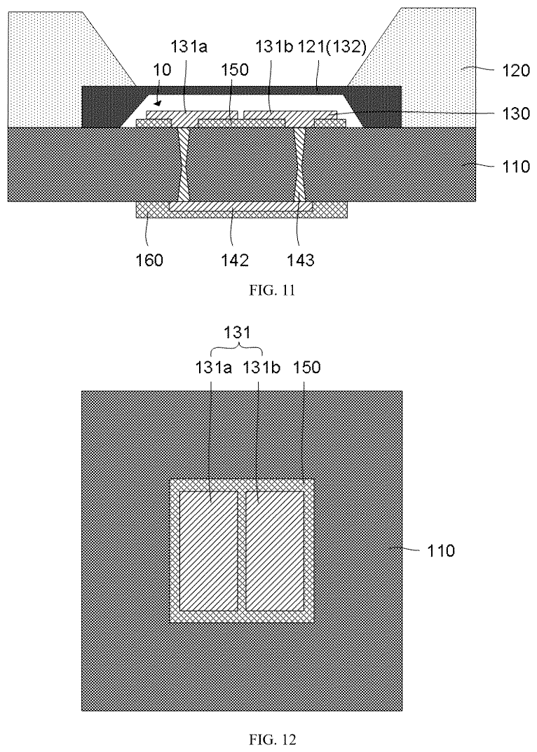

The capacitor of the pressure sensor 100 may include a first capacitor and a second capacitor connected in series. FIG. 10 schematically shows a circuit schematic diagram of another pressure sensor. As shown in FIG. 10, one end of the detection inductor L1 is electrically connected to the first capacitor C1, the other end of the detection inductor L1 is electrically connected to the second capacitor C2, and the first capacitor C1 is electrically connected to the second capacitor C2.

FIG. 11 is a sectional view along C-C in FIG. 8. FIG. 12 schematically shows a top view of the pressure sensor with the second substrate removed. As shown in FIG. 11 and FIG. 12, the first electrode plate 131 includes a first sub-electrode plate 131a and a second sub-electrode plate 131b that are arranged separately. The separate arrangement of the first sub-electrode plate 131a and the second sub-electrode plate 131b means that there is no direct physical connection between the first sub-electrode plate 131a and the second sub-electrode plate 131b. For example, a gap exists between the first sub-electrode plate 131a and the second sub-electrode plate 131b.

The first sub-electrode plate 131a and the second electrode plate 132 form the first capacitor, and the second sub-electrode plate 131b and the second electrode plate 132 form the second capacitor. Since the first capacitor and the second capacitor share the second electrode plate 132, the first capacitor and the second capacitor are substantially connected in series.

When the detection inductor and the capacitors are connected in series to form an inductance-capacitance resonant circuit, the first end of the detection inductor may be electrically connected to the first sub-electrode plate 131a, and the second end of the detection inductor may be electrically connected to the second sub-electrode plate 131b. Compared with the situation where one end of the detection inductor is electrically connected to the first electrode plate 131 and the other end of the detection inductor is electrically connected to the second electrode plate 132, since both the first sub-electrode plate 131a and the second sub-electrode plate 131b are located on the side of the first substrate 110 facing the second substrate 120, it is more convenient to connect the detection inductor and the capacitors.

Continuing to refer to FIG. 5, the pressure sensor 100 may also include a first conductive layer 130. The first conductive layer 130 is located on the side of the first trace 141 away from the first substrate 110, and the first sub-electrode plate 131a and the second sub-electrode plate 131b are located in the first conductive layer 130.

On the one hand, the distance between the first conductive layer 130 and the second electrode plate 132 is closer, so that the capacitance values of the first capacitor and the second capacitor are less likely to be interfered by the first trace 141. On the other hand, compared with the situation where the first conductive layer 130 is located between the first trace 141 and the first substrate 110, when the first conductive layer 130 is located on the side of the first trace 141 away from the first substrate 110, the distance between the first trace 141 and the conductive post 143 is closer, which facilitates the electrical connection between the first trace 141 and the conductive post 143.

The capacitance value of the first capacitor is c1, and the capacitance value of the second capacitor is c2. The capacitance value of the first capacitor C1 and the second capacitor C2 connected in series is c=(c1+c2)/c1*c2. It can be known from this that, on the premise that the sum of the capacitance value cl and the capacitance value c2 is fixed (on the premise that the dimension of the first electrode plate 131 is fixed), when the capacitance value cl of the first capacitor is equal to the capacitance value c2 of the second capacitor, the capacitance value c of series connection is maximum.

Since the first sub-electrode plate 131a and the second sub-electrode plate 131b are arranged in the same layer, the distance between the first sub-electrode plate 131a and the second electrode plate 132 is equal to the distance between the second sub-electrode plate 131b and the second electrode plate 132. In order to make the capacitance value c1 of the first capacitor C1 equal to the capacitance value c2 of the second capacitor C2, a first area and a second area can be made equal, where the first area is an orthogonal projection area of the first sub-electrode plate 131a with respect to the second electrode plate 132, and the second area is an orthogonal projection area of the second sub-electrode plate 131b with respect to the second electrode plate 132.

Exemplarily, the area of the first sub-electrode plate 131a is equal to the area of the second sub-electrode plate 131b.

Continuing to refer to FIG. 5, the pressure sensor 100 also includes a second conductive layer and a first insulation layer 150. The first trace 141 is located in the second conductive layer, and the first insulation layer 150 is located between the first conductive layer 130 and the second conductive layer. By disposing the first insulation layer 150 between the first conductive layer 130 and the second conductive layer, short-circuiting between the first trace 141 located between the two ends of the detection inductor and the first electrode plate 131 can be avoided.

Exemplarily, to reduce the parasitic capacitance formed between the first trace 141 and the first electrode plate 131, the first insulation layer 150 may be made of an insulation material with a low dielectric constant, such as silicon oxide, silicon nitride, and polyimide (abbreviated as PI).

Exemplarily, the thickness of the first insulation layer 150 is 0.1 to 10 μm.

Either the first trace 141 or the conductive post 143 may be located at the end of the detection inductor.

Exemplarily, both the first end and the second end of the detection inductor are the first trace 141. The first trace 141 located at the first end of the detection inductor is electrically connected to the first sub-electrode plate 131a. The first trace 141 located at the second end of the detection inductor is electrically connected to the second sub-electrode plate 131b. For example, the first insulation layer 150 is provided with a via hole 151, and the first trace 141 is electrically connected to the second sub-electrode plate 131b through the via hole 151.

Exemplarily, as shown in FIG. 8, both the first end and the second end of the detection inductor are the conductive posts 143. The conductive post 143 located at the first end of the detection inductor is electrically connected to the first sub-electrode plate 131a. For example, the first insulation layer 150 is provided with a via hole 151, and the conductive post 143 is electrically connected to the first sub-electrode plate 131a through the via hole 151. The conductive post 143 located at the second end of the detection inductor is electrically connected to the second sub-electrode plate 131b. For example, the first insulation layer 150 is provided with a via hole 151, and the conductive post 143 is electrically connected to the second sub-electrode plate 131b through the via hole 151.

Exemplarily, the first end of the detection inductor is the first trace 141, and the second end of the detection inductor is the conductive post 143. The first trace 141 located at the first end of the detection inductor is electrically connected to the first sub-electrode plate 131a through the via hole 151, and the conductive post 143 located at the second end of the detection inductor is electrically connected to the second sub-electrode plate 131b through the via hole 151.

When the capacitor includes the first capacitor and the second capacitor, the second electrode plate 132 may include a third sub-electrode plate and a fourth sub-electrode plate that are arranged separately. The third sub-electrode plate and the first electrode plate 131 form the first capacitor, and the fourth sub-electrode plate and the first electrode plate 131 form the second capacitor. The first end of the detection inductor is electrically connected to the third sub-electrode plate, and the second end of the detection inductor is electrically connected to the fourth sub-electrode plate.

The separate arrangement of the third sub-electrode plate and the fourth sub-electrode plate means that there is no direct physical connection between the third sub-electrode plate and the fourth sub-electrode plate. For example, a gap exists between the third sub-electrode plate and the fourth sub-electrode plate.

Compared with the situation where one end of the detection inductor is electrically connected to the first electrode plate 131 and the other end of the detection inductor is electrically connected to the second electrode plate 132, since both the third sub-electrode plate and the fourth sub-electrode plate are located on the second substrate 120, it is more convenient to connect the detection inductor and the capacitor.

The capacitance value of the first capacitor is c1, and the capacitance value of the second capacitor is c2. The capacitance value of the first capacitor C1 and the second capacitor C2 connected in series is c=(c1+c2)/c1*c2. It can be known from this that, on the premise that the sum of the capacitance value c1 and the capacitance value c2 is fixed (on the premise that the dimension of the second electrode plate 132 is fixed), when the capacitance value c1 of the first capacitor is equal to the capacitance value c2 of the second capacitor, the capacitance value c of the series connection is maximum.

Since both the third sub-electrode plate and the fourth sub-electrode plate are arranged on the pressure-sensitive membrane 121, the distance between the third sub-electrode plate and the first electrode plate 131 is equal to the distance between the fourth sub-electrode plate and the first electrode plate 131. In order to make the capacitance value c1 of the first capacitor C1 equal to the capacitance value c2 of the second capacitor C2, the area of a region where the third sub-electrode plate is directly opposite to the first electrode plate 131 can be made equal to the area of a region where the fourth sub-electrode plate is directly opposite to the first electrode plate 131.

Exemplarily, the area of the third sub-electrode plate is equal to the area of the fourth sub-electrode plate.

When the second substrate 120 is a silicon substrate, part of the region of the second substrate 120 may be doped to form the second electrode plate 132.

Exemplarily, the second substrate 120 includes a central region and an edge region surrounding the central region. The thickness of the central region is thinner than that of the edge region. The concentration of carriers in the central region is increased through doping to form the second electrode plate 132. That is, the central region is served as both the pressure-sensitive membrane 121 and the second electrode plate 132. Compared with forming the second electrode plate 132 on the pressure-sensitive membrane 121, the number of film layers is reduced, making the thickness of the pressure sensor 100 thinner.

Exemplarily, the second substrate 120 is provided with a groove on both the side facing the first substrate 110 and the side away from the first substrate 110 thereof. The thin film formed between the two grooves is the pressure-sensitive membrane 121. The pressure-sensitive membrane 121 undergoes a doping process to increase the concentration of carriers in the pressure-sensitive membrane 121 and form the second electrode plate 132.

Of course, an additional conductive layer may also be deposited on the surface of the second substrate 120 to form the second electrode plate 132. For example, when the second substrate 120 is a glass substrate, a metal layer is deposited on the surface of the glass substrate, and patterned to form the second electrode plate 132.

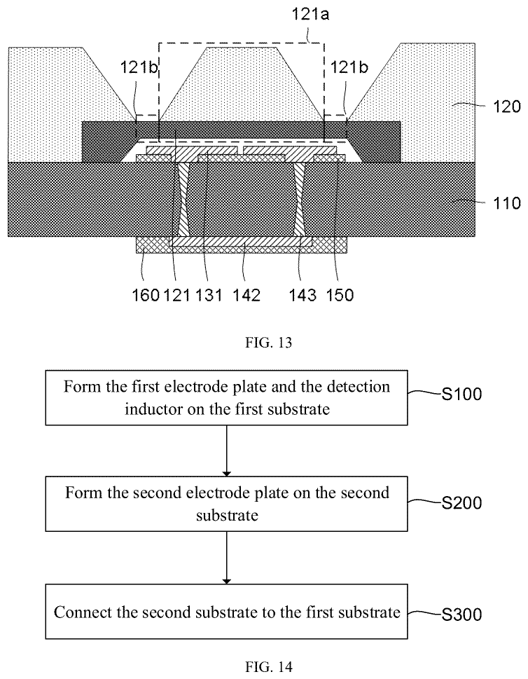

FIG. 13 schematically shows a cross-sectional view of another pressure sensor. As shown in FIG. 13, the pressure-sensitive membrane 121 includes a first region 121a and a second region 121b surrounding the first region 121a. The edge of the second region 121b away from the first region 121a is fixed, and the thickness of the first region 121a is greater than that of the second region 121b.

The thicker the pressure-sensitive membrane 121 is, the stiffer it is and the less likely it is to undergo elastic deformation. Conversely, the thinner the pressure-sensitive membrane 121 is, the less stiff it is and the more likely it is to undergo elastic deformation. Since the thickness of the second region 121b is smaller than that of the first region 121a, the second region 121b is more likely to undergo elastic deformation compared to the first region 121a.

In the case that the thickness difference of the first region 121a and the second region 121b meets a preset value, when the pressure-sensitive membrane 121 is subjected to pressure, the first region 121a will not undergo elastic deformation while the second area 121b will undergo elastic deformation. For example, when the pressure-sensitive membrane 121 is subjected to pressure directed towards the first substrate 110, the second region 121b undergoes elastic deformation, causing the first region 121a to translate towards the first substrate 110 as a whole. In this way, the change in the capacitance value in the pressure sensor 100 is more linear.

Among them, within the first region 121a, the thickness of the pressure-sensitive membrane 121 may be the same, or different. Alternatively, the thickness of some regions in the first region 121a is the same while the thickness of the remaining regions changes gradually.

Exemplarily, the first region 121a includes a first sub-region and a second sub-region surrounding the first sub-region. Within the first sub-region, the thickness of the pressure-sensitive membrane 121 is the same. Within the second sub-region, the thickness of the pressure-sensitive membrane 121 gradually increases in the direction towards the first sub-region.

Various ways may be used to make the thickness of the first region 121a greater than that of the second region 121b.

Exemplarily, the pressure-sensitive membrane 121 may be provided with a thickening layer at a position corresponding to the first region 121a to increase the thickness of the first region 121a. For example, a thickening layer is formed on the side of the first region 121a away from the first substrate 110 by means of deposition, bonding or adhesion.

Exemplarily, the second substrate 120 is provided with a groove at a position corresponding to the second region 121b. By providing the groove, the thickness of the second region 121b is made thinner than that of the first region 121a. The thickness of the second region 121b is made thinner than that of the first region 121a by providing a groove in the second region 121b, thus the process is simpler.

The groove may be located on the side of the second substrate 120 away from the first substrate 110, or it may be located on the side of the second substrate 120 facing the first substrate 110. When the groove is provided on the side of the second substrate 120 away from the first substrate 110, the area of the second electrode plate 132 can be increased, thereby increasing the capacitance value of the capacitor.

An embodiment of this application also provides a preparation method for a pressure sensor, by which the above-mentioned pressure sensor 100 is prepared. FIG. 14 schematically shows a flowchart of a preparation method for a pressure sensor. As shown in FIG. 14, the preparation method for the pressure sensor includes steps described below.

At S100, the first electrode plate and the detection inductor are formed on the first substrate.

The detection inductor is an inductor with a three-dimensional structure, including a plurality of coil structures connected in sequence. The coil structure includes the first trace, the second trace and the conductive post. The first trace is arranged on the side of the first substrate facing the second substrate, the second trace is arranged on the side of the first substrate away from the second substrate, the orthographic projection of the first trace on the first substrate intersects with the orthographic projection of the second trace on the first substrate, and the first trace and the second trace are electrically connected at the intersection positions through the conductive post.

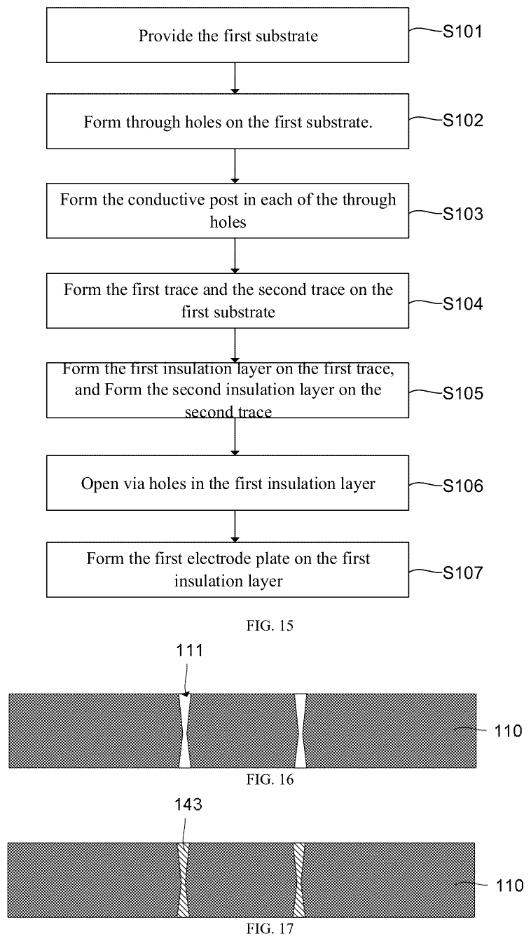

Exemplarily, as shown in FIG. 15, step S100 may include the following sub-steps.

At S101, the first substrate is provided.

Exemplarily, the first substrate is a glass substrate.

At S102, through holes are formed on the first substrate.

As shown in FIG. 16, the through holes 111 penetrate through the first substrate 110 in the direction perpendicular to the first substrate 110.

Exemplarily, a region on the first substrate 110 required to form the through holes 111 is modified by laser induction, so that the Si—O molecular bonds in such region are broken. Then, the through holes 111 are formed by etching the first substrate 110 through wet etching. Since the region on the first substrate 110 required to form the through holes 111 has been modified, the etching speed in this region is much greater than that in unmodified regions.

Etching may be carried out with hydrofluoric acid at room temperature, and the etching angle is 80° to 85° at this time. Etching may also be carried out with sodium hydroxide at a high temperature of 100° C. to 120° C., and the etching angle is 85° to 88° at this time. Of course, potassium hydroxide may also be used for etching.

In a direction from the side surface of the first substrate 110 to the inside of the first substrate 110, the diameter of the through hole 111 gradually decreases, so that the through hole 111 is in the shape of an hourglass with large ends and a small middle. Among them, the size at the largest diameter is 5 to 20 μm, and the size at the smallest diameter is 1 to 20 μm.

Exemplarily, a plurality of through holes 111 are formed on the first substrate 110, and the plurality of through holes 111 are arranged in an array to form a first through hole column, a second through hole column and a plurality of through hole rows. The first through hole column includes a plurality of first through holes 111 arranged at intervals in the first direction, the second through hole column includes a plurality of second through holes 111 arranged at intervals in the first direction, and each through hole row includes one first through hole 111 and one second through hole 111 arranged at intervals in the second direction. The first direction intersects with the second direction. At S103, the conductive post is formed in each of the through holes.

As shown in FIG. 17, the conductive post 143 penetrates through the first substrate 110 in the direction perpendicular to the first substrate 110, so that the ends of the conductive post 143 are exposed from the first substrate 110. The conductive post 143 is made of conductive materials.

Exemplarily, an adhesion layer may be deposited on the inner wall of the through hole 111 first, and then the through hole 111 is filled with a conductive material to form the conductive post 143. The adhesion layer may be one or more of Ti, Cu, and TaN. The conductive material filled in the through hole 111 may be one or more of Cu, W, and Al.

Since the through holes 111 are arranged in an array, the formed conductive posts 143 are also arranged in an array to form a first conductive post column, a second conductive post column and a plurality of conductive post rows. The first conductive post column includes a plurality of first conductive posts arranged at intervals in the first direction, the second conductive post column includes a plurality of second conductive posts arranged at intervals in the first direction, and the conductive post row includes one first conductive post and one second conductive post arranged at intervals in the second direction.

At S104, the first trace and the second trace are formed on the first substrate.

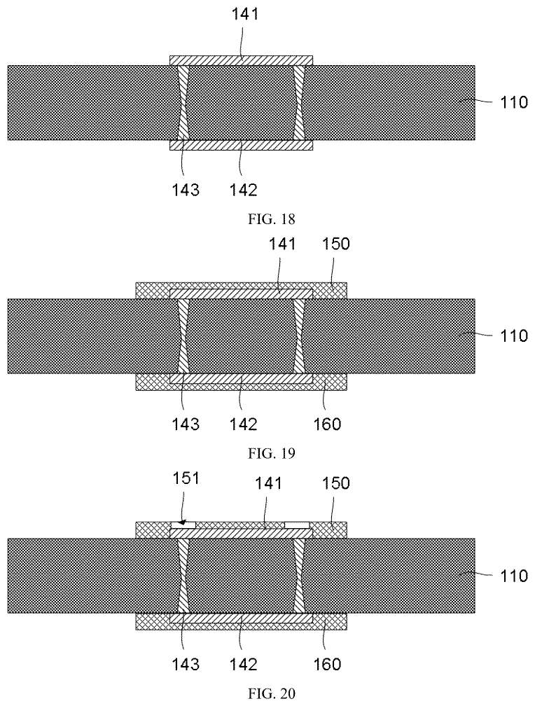

As shown in FIG. 18, the first trace 141 is formed on one side of the first substrate 110, and the second trace 142 is formed on the opposite side of the first substrate 110. There may be a plurality of first traces 141 and second traces 142.

One end of the first trace 141 is electrically connected to a first conductive post located in one conductive post row, and the other end of the first trace 141 is electrically connected to a second conductive post located in another adjacent conductive post row. One end of the second trace 142 is electrically connected to one first conductive post located in one conductive post row, and the other end of the first trace 141 is electrically connected to one second conductive post located in the same conductive post row. Thus, the first trace 141, the second trace 142 and the conductive post 143 are connected to form the detection inductor.

At S105, the first insulation layer is formed on the first trace, and the second insulation layer is formed on the second trace.

The structures of the first insulation layer 150 and the second insulation layer 160 are shown in FIG. 19.

Among them, the first insulation layer 150 and the second insulation layer 160 may be made of PI, SiO, SiN, etc., and the thickness thereof may be 0.1 to 10 μm.

At S106, via holes are opened in the first insulation layer.

As shown in FIG. 20, the via holes 151 are located in regions in the first insulation layer 150 corresponding to the ends of the detection inductor. For example, one via hole 151 is provided to correspond to the first end of the detection inductor, and one via hole 151 is provided to correspond to the second end of the detection inductor.

At S107, the first electrode plate is formed on the first insulation layer.

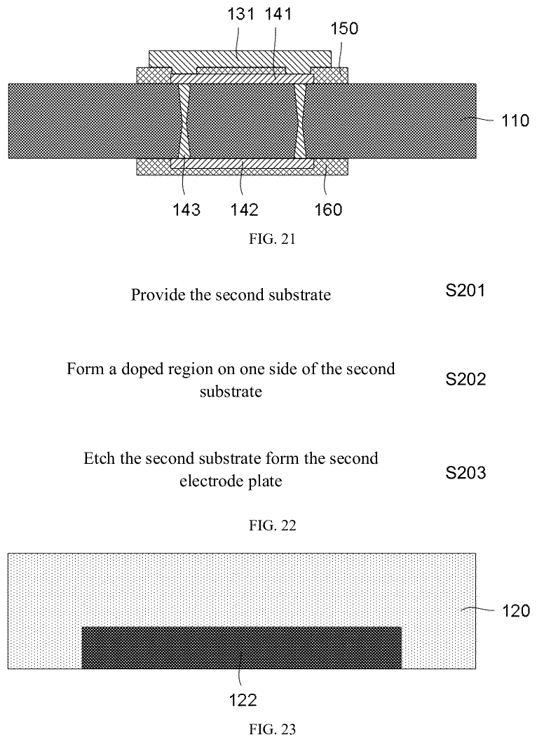

As shown in FIG. 21, the first electrode plate 131 is electrically connected to the first trace 141 through the via hole.

Exemplarily, the material of the first electrode plate 131 may be one or more of Au, Al, and Cu, and the thickness is 10 to 1000 nm.

Exemplarily, when the first electrode plate 131 is formed by deposition, part of the material is filled into the via hole 151 so that the first electrode plate 131 is electrically connected to the end of the detection inductor.

Exemplarily, the first electrode plate 131 is patterned to form the first sub-electrode plate and the second sub-electrode plate that are arranged separately.

At S200, the second electrode plate is formed on the second substrate.

The second substrate includes the pressure-sensitive membrane, and the second electrode plate is arranged on the pressure-sensitive membrane.

Exemplarily, the second substrate is a silicon substrate.

The process of forming the second electrode plate on the second substrate is introduced in details below by using a silicon substrate as the second substrate as an example. As shown in FIG. 20, step S200 may include the following sub-steps.

At S201, the second substrate is provided.

At S202, a doped region is formed on one side of the second substrate.

As shown in FIG. 23, the second substrate 120 includes a first side surface and a second side surface that are opposite to each other, and a doped region 122 is formed on the first side surface.

Exemplarily, the second substrate 120 includes a central region and an edge region surrounding the central region. The central region of the second substrate 120 is doped and modified by a heavy doping process such as ion implantation or diffusion to form the doped region 122, so as to improve the conductivity of the doped region 122.

Exemplarily, the depth of modification may be 0.1 to 5 μm.

Exemplarily, the sheet resistance after modification is less than or equal to 100 Ω/SQ.

At S203, the second substrate is etched to form the second electrode plate.

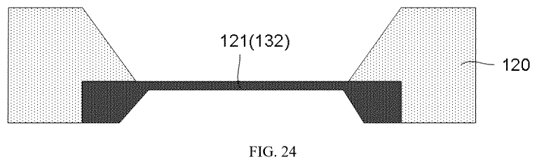

Referring to FIG. 24, exemplarily, anisotropic etching of the second substrate 120 is carried out using etchants such as KOH and TMAH. Since the etching rate of the heavily doped region by the etchant is much lower than that of the undoped region, and the etching rate ratio is about 1:50 to 200, when the second substrate 120 is etched from the second side surface to the heavily doped region, the etching will automatically stop. The etching rate on the first side surface of the second substrate 120 is slow, forming grooves with a depth of 0.1 to 3 μm. At the same time, the second substrate 120 is etched from both the first side and the second side of the second substrate 120, and the formed thin layer structure is served both as the pressure-sensitive membrane 121 and the second electrode plate 132.

Among them, grooves are formed on both sides of the second substrate 120 after etching, and the openings of the grooves gradually increase in the direction away from the second substrate 120, as shown in FIG. 24. Exemplarily, the angle between the side wall of the groove and the horizontal plane shown in the figure is 54.7°.

Exemplarily, when the pressure-sensitive membrane 121 includes a first region and a second region surrounding the first region, and the thickness of the first region is greater than that of the second region, when etching the second side surface of the second substrate 120, only the region corresponding to the second region can be etched, so that the second substrate 120 forms a groove corresponding to the second region, making the thickness of the second region thinner than that of the first region.

At S300, the first substrate is connected to the second substrate.

After the first substrate 110 and the second substrate 120 are connected, a sealed pressure reference cavity 10 is formed between the pressure-sensitive membrane 121 and the first substrate 110. The pressure-sensitive membrane 121 can deform towards or away from the first substrate 110. The first electrode plate 131 and the second electrode plate 132 form a capacitor, and the detection inductor and the capacitor are connected in series to form an inductance-capacitance resonant circuit.

When the first substrate 110 is a glass substrate and the second substrate 120 is a silicon substrate, the first substrate 110 and the second substrate 120 can form wafer bonding by using an anodic bonding process. Of course, the first substrate 110 and the second substrate 120 can also be connected in other ways, such as adhesion, metal bonding, etc.

In the preparation method for the pressure sensor provided in the embodiments of this application, the detection inductor in the prepared pressure sensor is an inductor with a three-dimensional structure formed on the first substrate. Compared with the ferrite core inductor in the related art, the detection inductor in the embodiments of this application can be formed on the first substrate by using MEMS technology, which improves the integration degree of the pressure sensor and reduces the volume of the pressure sensor. Compared with the planar inductor in the related art, the detection inductor in the embodiments of this application is an inductor with a three-dimensional structure, including multi-turn coil structures, which increases the inductance and thus improves the signal transmission quality between the read inductor and the detection inductor. Therefore, the volume of the pressure sensor is reduced on the premise of maintaining a relatively high signal transmission quality.

The above is only the specific implementations of this application, while the protection scope of this application is not limited thereto. Those skilled in the art can easily conceive of changes or replacements within the technical scope disclosed by this application, and all of them should be covered within the protection scope of this application. Therefore, the protection scope of this disclosure should be determined by the scope of the claims.

1. A pressure sensor, comprising:
a first substrate;
a second substrate, wherein the second substrate comprises a pressure-sensitive membrane that is opposite to and spaced apart from the first substrate, a sealed pressure reference cavity is provided between the pressure-sensitive membrane and the first substrate, and the pressure-sensitive membrane is configured to deform towards or away from the first substrate;
a capacitor, comprising a first electrode plate and a second electrode plate arranged opposite to each other, the first electrode plate being disposed on the first substrate, and the second electrode plate being disposed on the pressure-sensitive membrane;
a detection inductor, comprising a plurality of coil structures connected in sequence, wherein each of the coil structures comprises a first trace, a second trace and a conductive post;
the first trace is disposed on a side of the first substrate facing the second substrate, the second trace is disposed on a side of the first substrate away from the second substrate, an orthographic projection of the first trace on the first substrate and an orthographic projection of the second trace on the first substrate intersect with each other, and the first trace is electrically connected to the second trace at an intersection position through the conductive post;
wherein the detection inductor and the capacitor are connected in series to form an inductance-capacitance resonant circuit.

2. The pressure sensor according to claim 1, wherein the capacitor comprises a first capacitor and a second capacitor, the first electrode plate comprises a first sub-electrode plate and a second sub-electrode plate that are arranged separately, the first sub-electrode plate and the second electrode plate form the first capacitor, and the second sub-electrode plate and the second electrode plate form the second capacitor;
wherein a first end of the detection inductor is electrically connected to the first sub-electrode plate, and a second end of the detection inductor is electrically connected to the second sub-electrode plate.

3. The pressure sensor according to claim 2, further comprising a first conductive layer located on a side of the first trace away from the first substrate, wherein the first sub-electrode plate and the second sub-electrode plate are located in the first conductive layer.

4. The pressure sensor according to claim 3, wherein an orthogonal projection area of the first sub-electrode plate with respect to the second electrode plate is a first area, an orthogonal projection area of the second sub-electrode plate with respect to the second electrode plate is a second area, and the first area is equal to the second area.

5. The pressure sensor according to claim 3, further comprising a second conductive layer and a first insulation layer, wherein the first trace is located in the second conductive layer, and the first insulation layer is arranged between the first conductive layer and the second conductive layer.

6. The pressure sensor according to claim 5, wherein the first end of the detection inductor is the first trace, and the first trace is electrically connected to the first sub-electrode plate through a via hole.

7. The pressure sensor according to claim 5, wherein the second end of the detection inductor is the conductive post, and the conductive post is electrically connected to the first sub-electrode plate through a via hole.

8. The pressure sensor according to claim 1, wherein the capacitor comprises a first capacitor and a second capacitor, the second electrode plate comprises a third sub-electrode plate and a fourth sub-electrode plate that are arranged separately, the third sub-electrode plate and the first electrode plate form the first capacitor, and the fourth sub-electrode plate and the first electrode plate form the second capacitor;
a first end of the detection inductor is electrically connected to the third sub-electrode plate, and a second end of the detection inductor is electrically connected to the fourth sub-electrode plate.

9. The pressure sensor according to claim 1, wherein the second substrate is a silicon substrate, and partial region of the second substrate is doped and forms the second electrode plate.

10. The pressure sensor according to claim 1, wherein the pressure-sensitive membrane comprises a first region and a second region surrounding the first region, an edge of the second region away from the first region is fixed, and a thickness of the first region is greater than that of the second region.

11. The pressure sensor according to claim 10, wherein the second substrate is provided with a groove, and the groove is located in the second region.

12. The pressure sensor according to claim 11, wherein the groove is located on a side of the second substrate away from the first substrate.

13. The pressure sensor according to claim 1, wherein the conductive posts are arranged in an array to form a first conductive post column, a second conductive post column and a plurality of conductive post rows, wherein the first conductive post column comprises a plurality of first conductive posts arranged at intervals in a first direction, the second conductive post column comprises a plurality of second conductive posts arranged at intervals in the first direction, and each of the conductive post rows comprises one of the first conductive posts and one of the second conductive posts arranged at intervals in a second direction, the first direction and the second direction intersect with each other;
wherein one end of the first trace is electrically connected to one of the first conductive posts located in one of the conductive post rows, and the other end of the first trace is electrically connected to one of the second conductive posts located in another adjacent one of the conductive post rows;
one end of the second trace is electrically connected to one of the first conductive posts located in one of the conductive post rows, and the other end of the second trace is electrically connected to one of the second conductive posts located in the same one of the conductive post rows.

14. The pressure sensor according to claim 1, wherein a second insulation layer is provided on a side of the second trace away from the first substrate.

15. A preparation method for a pressure sensor, comprising:
forming a first electrode plate and a detection inductor on a first substrate, wherein the detection inductor comprises a plurality of coil structures connected in sequence, each of the coil structures comprises a first trace, a second trace and a conductive post, the first trace is disposed on a side of the first substrate facing the second substrate, the second trace is disposed on a side of the first substrate away from the second substrate, an orthographic projection of the first trace on the first substrate and an orthographic projection of the second trace on the first substrate intersect with each other, and the first trace is electrically connected to the second trace at an intersection position through the conductive post;
forming a second electrode plate on a second substrate, wherein the second substrate comprises a pressure-sensitive membrane, and the second electrode plate is arranged on the pressure-sensitive membrane;
connecting the first substrate to the second substrate; after the first substrate is connected to the second substrate, a sealed pressure reference cavity is formed between the pressure-sensitive membrane and the first substrate, the pressure-sensitive membrane is allowed to deform towards or away from the first substrate, the first electrode plate and the second electrode plate form a capacitor, and the detection inductor and the capacitor are connected in series to form an inductance-capacitance resonant circuit.

16. A detection device, comprising:
the pressure sensor according to claim 1; and
a detection circuit comprising a read inductor, wherein the read inductor is configured to be coupled with the detection inductor in the pressure sensor to read a resonant frequency of the pressure sensor.

17. The preparation method according to claim 15, wherein the forming a first electrode plate and a detection inductor on a first substrate comprises:
providing the first substrate;
forming through holes on the first substrate;
forming the conductive post in each of the through holes;
forming the first trace and the second trace on the first substrate;
forming a first insulation layer on the first trace, and forming a second insulation layer on the second trace;
opening via holes in the first insulation layer; and
forming the first electrode plate on the first insulation layer.

18. The preparation method according to claim 15, wherein the forming a second electrode plate on a second substrate comprises:
providing the second substrate;
forming a doped region on one side of the second substrate; and
etching the second substrate and forming the second electrode plate.
